(19) United States
(12) Patent Application Publication
(10) Pub. No.: US 2004/0093582 A1
(43) Pub. Date: May 13, 2004

(54) Method for allowing a computer to be used as an information kiosk while locked

(76) Inventor: Tim E. Segura, Bellevue, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/699,266

(22) Filed: Oct. 31, 2003

Related U.S. Application Data
(60) Provisional application No. 60/423,139, filed on Nov. 1, 2002.

(51) Int. Cl. G06F 9/44

(52) U.S. Cl. 717/102; 717/113; 717/105

(57) ABSTRACT

A method for limiting access to resources of a personal computer with an operating system while allowing access to information via a web browser program. The method includes running on the personal computer a locking program that modifies functions of the web browser program and functions of the operating system to disable functions that allow access to any data file in a memory of the computer other than web browser access to a specified list of URL's until an authenticating input is received by the computer. The method may further include launching the web browser program if it is not already launched. The method may further include a delay from the running of the locking program until it disables functions of the operating system and the web browser program such that disabling is commenced upon expiration of a set amount of time without keyboard or mouse input activity.

### BACKGROUND

Many personal computer owners wish to lock their computers against access by others when they leave the computer. Software to do so is well known but limited and is sometimes provided with popular operating systems. In typical operation of the locking software, the locking module is activated during computer start-up, upon user demand, or when there has been no user input to the computer from the keyboard or the mouse for a certain length of time. Once activated, the screen display typically shows a screen saver program comprised of one or more images or a static web page (in effect, a captured Image) which are frequently changed on the display so no one spot on a cathode ray tube (CRT) display becomes burned. Alternatively, some locking software modules cause the screen display to go blank (not using any images). Then, when a user moves the mouse or presses a key, a window is presented on the display requesting the entry of a password to unlock the computer.

When the computer is locked, input from the keyboard or from the mouse causes no reaction by the computer other than displaying the window which asks for a password to unlock the computer. Generally, processes which were set to operate automatically before the computer became locked will continue and operate as intended, such as continuation of a download or upload operation that was commenced before the computer was locked or launching of an executable program on a predetermined schedule according to a time on the computer's internal clock.

### SUMMARY OF THE INVENTION

In one aspect, the invention is a novel computer locking software program that, instead of entirely locking the computer and restricting the computer's reaction to user input to merely displaying an image or unlock window which requests a password, the computer, while locked, can be used as an information kiosk displaying a web page or allowing controlled interaction with other local or remote resources (applications and hardware) through a web browser based locking mechanism. This allows the user to follow any active link on the page to any other web page or resource; or enter a URL to which the browser will be directed. Allowable resources a user may access, keyboard interaction, and function availability are controlled through settings set by a user with administrator authority. Beyond an edge of the window showing the web page, such as at the bottom edge of the display or a side edge, clickable buttons are displayed by the locking software module, one of which is an “unlock” button which, when clicked, displays a window requesting a password. Additional buttons allow the user to configure locking mechanism options and activate advanced functions.

The first page that is shown when the computer is locked can be configured in the locking module so that the user cannot change it. Alternatively, that first page can be a page from a remote network server or can be a default web page resident within the user's computer which would be active if the computer is disconnected from the network. A web page can be based on any standard such as HTML, XML, ASP, PHP, etc. It might include embedded image, audio, or video files, or the web page itself can be an image, audio, or video file.

In one embodiment, the user is merely able to use the mouse to move the pointer and use the left button on the mouse to click on links displayed on the web page. The user cannot enter anything through the keyboard, cannot send printer data to a printer and cannot directly access any mass storage device such as a hard drive or a floppy drive to read or write a file as selected by the user. Of course, in the computer's normal operation, it will continue to access files on the hard drive or other mass storage device as controlled by executing programs. This means that ActiveX controls and java scripts will continue to run as activated by user clicks with the mouse button while the cursor is over a hot spot on a web page. However, the locking module may be configured to prevent downloads of files to the hard disk other than the temporary downloads of ActiveX programs java scripts, and the like. The task bar and menu controls of the web browser are hidden so that the only active spots on the screen which can cause a reaction by the computer are the active links in the web page, as well as the buttons added by the locking software module, one of which is an “unlock” button which, when clicked, displays a window requesting a password. The task bar (and buttons) can be viewable or in hidden mode and the unlocking password can be set to mandatory or optional.

In another embodiment, the locking software allows the user to enter letters, numbers, punctuation, spaces and tabs at the keyboard, use the backspace and delete keys for their normal editing functions, and use arrow keys and other cursor movement keys to navigate on a web page. In this embodiment, the accelerator keys, such as Ctrl-C, Shift-F10, Ctrl-P, etc. are disabled, as well as any keystroke combination that might allow a user to control any other program executing on the computer other than the web browser that is displaying the web page and the locking module that displays the unlock button. By allowing keyboard entry, this embodiment allows a user to direct the browser to any URL, use a search service, enter information at a website, and use the computer for web based email and similar text input requirements.

Other embodiments of the invention are described below. The invention may be incorporated into any computer operating system or serve as a GUI (Graphical User Interface) for other client or network based applications. The invention can be utilized as a stand alone application or complimentary to other applications.

### BRIEF DESCRIPTION OF THE FIGURES

The features of the present invention which are believed to be novel are set forth with particularity in the appended claims. Aspects of the invention may best be understood by making reference to the following description taken in conjunction with the accompanying figures wherein:

FIG. 1 shows the screen display of a typical computer locked in accordance with this invention.

FIG. 2 shows the process for locking and unlocking the computer.

FIG. 3 shows a process for determining support information to be displayed.

FIG. 4 shows a process for determining configuration information to be displayed.

FIG. 5 shows exemplary system architecture with a focus on the core code architecture.

### DETAILED DESCRIPTION

The following detailed description and the figures illustrate specific exemplary embodiments by which the invention may be practiced. Other embodiments may be utilized and other changes may be made without departing from the spirit or scope of the present invention. The following detailed description is therefore not to be taken in a limiting sense, and the scope of the present invention is defined by the stated claims.

The invention encompasses computer methods, computer programs on program carriers (such as disks or signals on computer networks) that, when run on a computer, implement the method, and computer systems with such a program installed for implementing the method. The various embodiments of the invention may be implemented as a sequence of computer implemented steps or program modules organized in any of many possible configurations. The implementation is a matter of choice dependent on the performance requirements of the computing system implementing the invention.

The invention may be embodied in software as an EXE file that installs on a user's computer. It provides the ability to:

A. Lock the computer when no input is received for a length of time.

B. Lock the computer when the computer starts.

C. Let an administrator set a password.

D. Let an administrator select a URL to use as the page that is displayed when the computer is locked.

E. Let any user obtain technical support via a web page or e-mail.

The above features may be provided in any combination. Additional alternative features are described below. The table below shows five examples which provide the above features in different combinations:

| VERSION | 1 | 2 | 3 | 4 | 5 |
|---|---|---|---|---|---|
| Feature A: | Yes | Yes | Yes | Yes | Yes |
| Feature B: | No | No | No | Yes | Yes |
| Feature C: | Preset* | Yes | Yes | Yes | Yes |
| Feature D: | Preset* | No | Yes | No | Yes |
| Feature E: | Yes | Yes | Yes | Yes | Yes |

*Preset means the feature is hard coded into the software and cannot be changed by the end user.

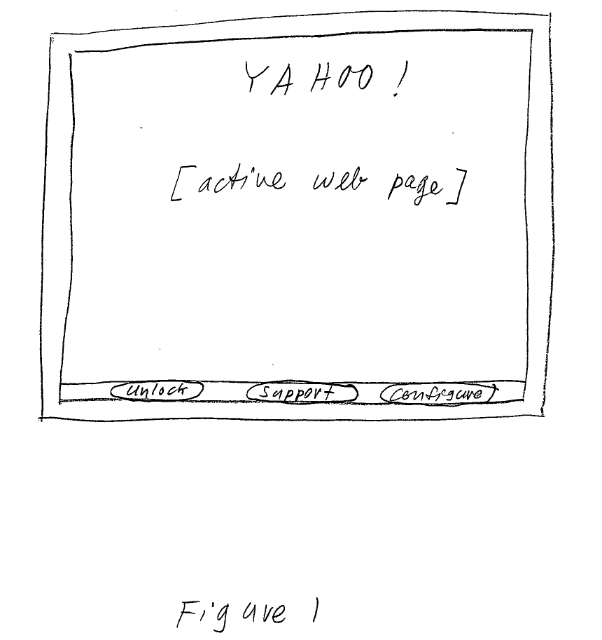

When the software installs, a desktop icon is placed on the user's desktop. If the user steps away from their computer they can simply click on the icon to lock their screen. If they fail to do so, the lock will be activated automatically after a set number of minutes with no keyboard or mouse activity. Other versions of the software automatically lock the computer when the computer starts up. If the computer is connected to the Web (Internet) when the lock is activated, the default URL will be accessed by the computer's web browser program and the URL's web page then covers the user's screen until the unlocking password is entered. If the computer is not connected to the Web (Internet or other network) a default web page (part of the installation) is used to cover the screen. Once locked, visible buttons include: Unlock, Support, and Configure, as shown in FIG. 1. Locking or unlocking operations can also be linked, synchronized, or scheduled with external hardware or software application events.

An exemplary embodiment may be coded using Visual Basic 6.0 SP4 which runs on all Windows operating systems. Alternatively, the invention may be implemented with other database programming systems providing similar functionality for any operating systems (Apple, Linux, CE, etc) running on personal computers, wireless hand held computers, and PDA devices.

Technical Description of Working of the System as Implemented for Windows Operating Systems

Components used other than standard windows dlls include:

Microsoft WebBrowser Control

Microsoft WebBrowser Customizer Sample object (WBCustomizer.dll) (included in the installation)

Wininet.dll

*On Startup

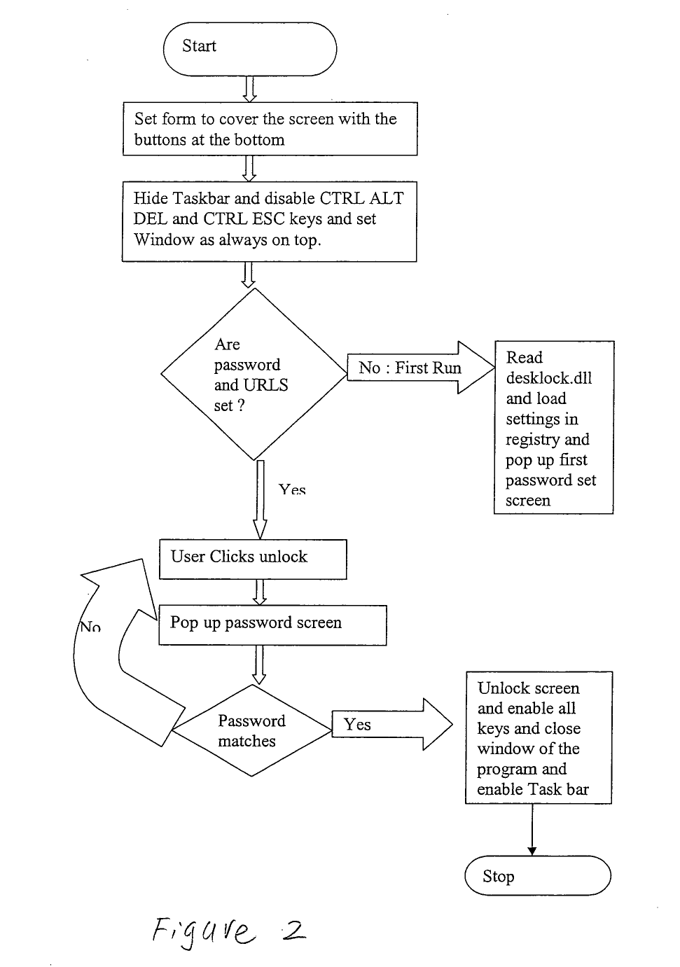

As shown in FIG. 2, Set form and control to cover the screen, with space only for buttons, as shown in FIG. 1.

Instantiate WBCustomizer object and use it to:

Disable accelerator keys(Ctrl-C, Shift-F10 etc)

Disable Right-click menu

Disable Control-Alt-Delete and Control-Escape Keys

Hide Taskbar

Set window as always on top

If the homepage and support page parameters are not set (first run) then

Read config file (desklock.dll) to get and save parameters.

If the password is not set, then

Show set new password form.

Check if connected to Internet (wininet.dll)

If yes then

download and show home page

Else

Show local home page

*On Clicking Support

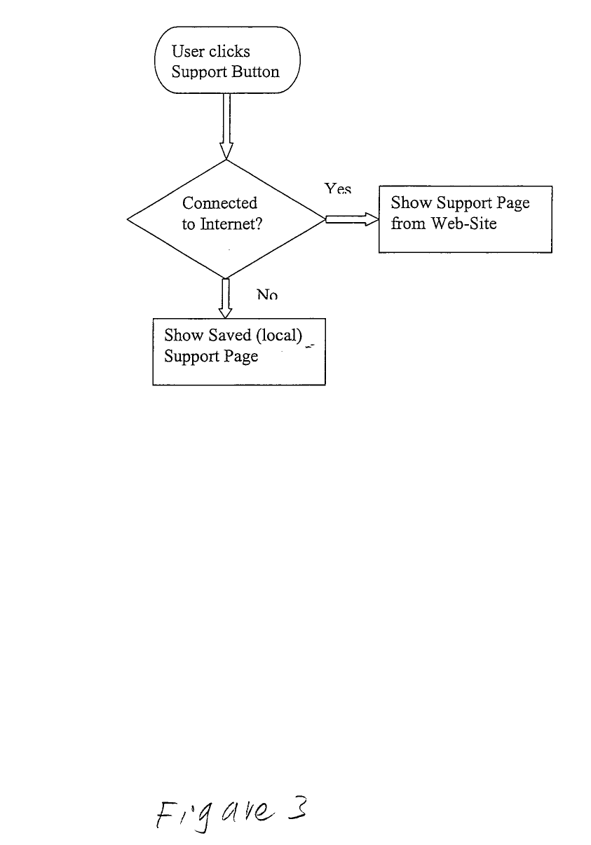

As shown in FIG. 3, check if connected to Internet (wininet.dll)

If yes

then download and show support page

Else

Show local support page

*On Clicking Unlock

Display Password Entry Form

*On Clicking Configure

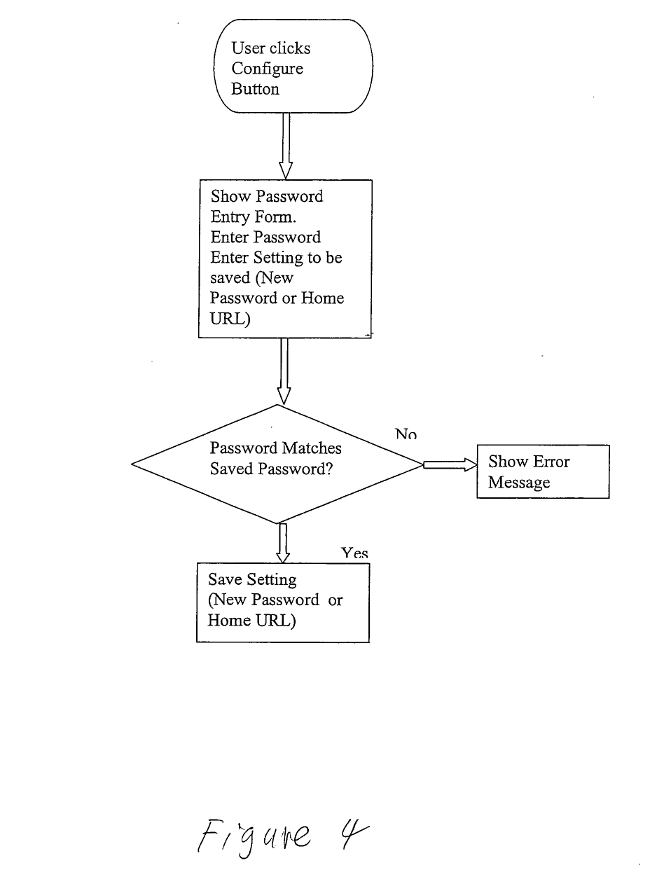

As shown in FIG. 4, display Configure Form and implement the following steps:

Save Password frame

If old password entered matches the saved password (encrypted) and the new password and confirmation of new password match then the password is saved to new password (encrypted).

Else

An error message is given

If old password entered matches the saved password (encrypted), the Homepage URL setting is changed.

Else

An error message is given

Password Entry Process

On Entering Password

If the password has not been set, then

the desktop unlocks with a blank password.

If the password has been set,

the password is compared with the saved password (only an encrypted version of the password is saved, the actual password is not saved) and if both match then

the desktop is unlocked.

Else

An error message is given.

Unlock Process.

Enable Control-Alt-Delete and Control-Escape Keys

Show taskbar

Disable Window always on Top

Customization

A Customized “Build” Process provides the ability to “brand” the software for each customer such as by changing colors, graphics, logos, etc. The final components are then assembled into a unique customer build by a compiler. Customization is typically performed on HTML and DLL files prior to running the compiler.

System Architecture

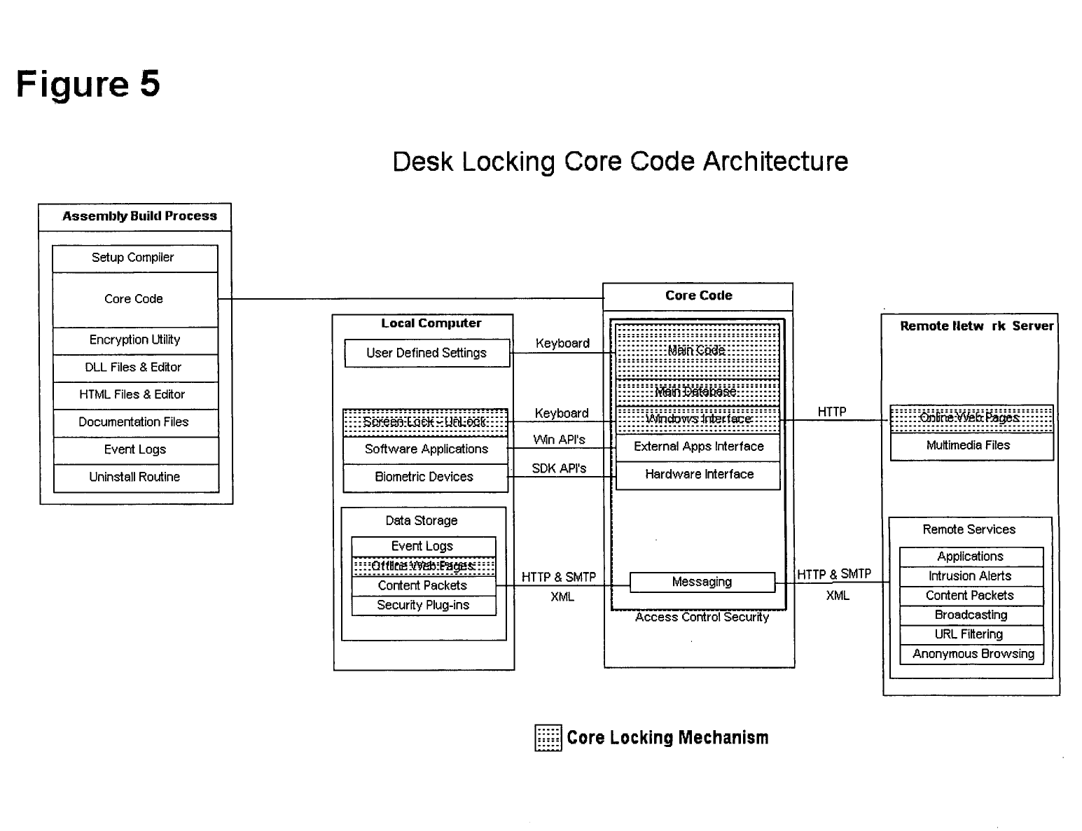

The system architecture is shown in FIG. 5. Some of the components shown in FIG. 5 are referenced in the following description of other features of the system. The core code components are indicated in FIG. 5.

Password Management

A second password level, in addition to the primary User password may be built into the software. Certain function settings may be controlled by the User, but others require the Administration password. The Administration password is encrypted during the “Build” process along with the features controlled by each respective password. Any standard encryption algorithm utility can be used to encrypt the passwords; the resulting password “hash” is placed inside the DLL file prior to running the compiler.

A User's Password can be set to expire at different time intervals, requiring the user to input a new and updated password. The Administrator can adjust how many days before the password must be updated and the format of the password required, for example, all caps, lowercase, alpha-numeric combination, etc. The Administrator Password can override the User Password. Password controls are embedded into the core code, but are adjustable within the settings menu.

Keyboard Management

The Administrator can control which keyboard keys are disabled in the Locked mode. For example, the Administrator may wish to lock particular keys while allowing others to be fully utilized. A good example is to Disable the Alt-Ctl-Delete key combination which will turn off the entire computer. Keyboard control options are embedded into the core code, but are adjustable within the settings menu.

Intrusion Monitoring Log

Each User Password that is input is logged into the software Event Log, it can be accessed by the User to determine if someone attempted to enter their computer and input the wrong password. Event Logs can also be automatically transmitted to a central administrator. Logs are standard ASCII text files sent according to SMTP, SMIME, HTTP, etc. when transmitted to a server.

Ability to Store Multiple URL's

Using the VB database within an embodiment of the software, the Administrator or user can store multiple web pages that are accessible from a locked state and designate one particular URL as the default locking page. A pop-up list of these URL's are available to the user when the screen is locked. The software Access Control Module prevents the browser from being directed to any URL other than those in the list. Groups of URL's arranged by category can be stored remotely or locally and through the Messaging Module these URL's can be transmitted within Content Packets. URL Content Packets are standard browser based Favorites format with a folder and text structure.

Managed IP Access Controls

The software Access Control Module manages which local or remote network resources can be accessed from a locked state as pre-determined by the Administrator. Only certain IP servers or IP domains or networks can be accessed. For example, the web paged used in locking may work for certain links but other external links may be disabled. Access controls are embedded into the core code, but are adjustable within the settings menu. Access control is simply creating an HTTP Channel running through Specific URL filters, stored in the core code, on the server, or in a third-party Security Plug-in.

Integration to Other Software Applications

The Screen Locking software can be used as a “Front End” interface to other software applications that reside either locally on the user's computer or any computer on the network. For example, if a password is input into the software to unlock the screen, it can pass that information to another application which it then launches. Standard Operating Systems calls are made to executable EXE files and subsequent events are Perl, XML, or Java scripts.

Integration to External Hardware

When locked, the software can communicate with external hardware through standard SDK API's. For example, a biometric device like a thumb print reader. When the user places their thumb on the external hardware device it will communicate with the software to unlock the screen. This has been accomplished using standard API's between the software and various hardware devices. Hardware manufactures provide standard SDK type API's.

Sound and Video Streaming Controls

When locked, the software can stream audio and video files. Buttons on the bottom control bar may include: Play, Stop, Pause, Sound On/Off switch. This streaming can be live or pre-recorded segments, using standard multi-media file formats. The software may leverage the default multimedia player included in all operating systems and used by the resident web browser.

To-Do Reminder List

Using the embedded VB database, there is reminder and to-do list capability. A user can create a custom task and assign it a due date. On the bottom control bar and on the User's desktop an icon is displayed Green if the task date is not yet passed, or Red if the task is past due. The user can complete out and close tasks.

Advanced Locking Screen Displays

This feature, allows multiple URL web pages to be displayed on the Locked screen in any configuration such as split horizontally, vertically, or a four quadrant display of a separate web page in each quadrant. One web page can also be set to transition into a different web page such as a dissolve or fly off the screen in a particular direction. Screen Display options are embedded into the core code, but are adjustable within the settings menu.

Content Packets, Courses, Tests, Surveys, Polls, Electronic Documents

This feature allows a user to participate in E-Learning or electronic processing types of tasks at various stages. The type of task and when the user must participate is determined by the Administrator. In addition, when a user inputs information, the software can communicate with a remote IP Server to perform a process or calculation, with results transmitted back to the local software, this can be at a scheduled or real-time interval. Processes are transmitted by the Messaging Module leveraging HTTP or an operating system default email client. Each copy of the software can be serialized; which allows controlled distribution where added packets are received intelligently based on the embedded serial number. Content Packets may include raw content, calculated results, broadcast messages, or even a self-contained EXE file. Content Packets use standard SMIME or ZIP compression if needed for larger content packets.

Remote Monitoring of Workstations to Server

The software can communicate with a remote IP Server, sending messages from a particular workstation to the server. For Example, the workstation can detect a wrong password attempting to unlock the screen, these intrusion attempts can be transmitted as alerts to the server which can forward these messages to the system administrator. Logs and Alerts are standard ASCII Text files sent in accordance with SMTP, SMIME, HTTP, etc. when transmitted to a server.

Remote Broadcasting, Server to Workstations

In some embodiments, the system includes an ability to send messages from a central IP Server to a particular workstation or a group of workstations. The message can be displayed either on the control bar of the software or as an update to the Page used to Lock the screen. Broadcasts can be used in conjunction with audio or video streaming. These types of tasks may be real-time or scheduled events within the Messaging Module. Remote broadcasting can also allow an Administrator to remotely change the branding, security, and functional aspects of the installed software. Broadcasts are typically HTML or XML, within SMTP, SMIME, HTTP, etc. when transmitted to a workstation.

Added Security Plug-Ins

This allows a user “in a locked state” to access and control security specific software modules such as: Anti-Virus, Firewalls, Spam-Control, Pop-Up Filters, etc. which can be added or subtracted as plug-ins by Administration settings. Standard Operating Systems calls are made to executable EXE files and subsequent events are Perl, XML, or Java scripts.

Anonymous Network Browsing

This allows a user “in a locked state” to browse any IP network without divulging their unique IP identifiers. This leverages public domain servers on the web to filter out IP information, we added a randomization and switching algorithm to this process.

Although the present invention has been described in considerable detail with reference to certain preferred embodiments, other embodiments are possible. Therefore, the spirit or scope of the appended claims should not be limited to the description of the embodiments contained herein. It is intended that the invention resides in the following claims.

I claim:

1. A method for limiting access to resources of a personal computer with an operating system while allowing access to information via a web browser program, comprising:
(a) running on the personal computer a locking program that modifies functions of the web browser program and functions of the operating system to disable functions that allow access to any data file in a memory of the computer other than web browser access to a specified list of URL's until an authenticating input is received by the computer.

2. The method of claim 1 further comprising launching the web browser program if it is not already launched.

3. The method of claim 1 further comprising a delay from the running of the locking program until it disables functions of the operating system and the web browser program such that disabling is commenced upon expiration of a set amount of time without keyboard or mouse input activity

4. The method of claim 1 where the authenticating input is the input of a password at a keyboard.

5. The method of claim 1 where the specified list contains only one URL.

6. The method of claim 5 where the specified URL is stored in a memory of the personal computer.

7. The method of claim 1 where the keyboard is locked and actions of pointer buttons other than a main button are locked and any other input method is locked except that the only input methods available to a user are pointer movement and main pointer button clicks.

8. The method of claim 7 where the authenticating input is provided by steps comprising:
(a) moving the pointer to a button at an edge of a screen display, and
(b) clicking the main pointer button.

9. A method for limiting access to resources of a personal computer with an operating system while allowing access to information via a web browser program, comprising:
(a) running on the personal computer a locking program that modifies functions of the web browser program and functions of the operating system to disable functions that allow access to any user accessible data in a memory of the computer other than web browser access to a web page specified by a first URL and any web page that can be reached by following active links from one page to another until an authenticating input is received by the computer.

10. The method of claim 9 further comprising launching the web browser program if it is not already launched.

11. The method of claim 9 further comprising a delay from the running of the locking program until it disables functions of the operating system and the web browser program such that disabling is commenced upon expiration of a set amount of time without keyboard or mouse input activity.

12. The method of claim 9 where the authenticating input is the input of a password at a keyboard.

13. The method of claim 9 where the keyboard is locked and actions of pointer buttons other than a main button are locked and any other input method is locked except that the only input methods available to a user are pointer movement and main pointer button clicks.

14. The method of claim 13 where the authenticating input is provided by steps comprising:
(a) moving the pointer to a button at an edge of a screen display, and
(b) clicking the main pointer button.
